(19) United States
(12) Patent Application Publication
(10) Pub. No.: US 2020/0130311 A1
(43) Pub. Date: Apr. 30, 2020

(54) METHOD FOR MANUFACTURING RUBBER BOOT HAVING FOAMED LINING LAYER

(71) Applicant: Chih-Yung Yu, Taichung City (TW)

(72) Inventor: Chih-Yung Yu, Taichung City (TW)

(21) Appl. No.: 16/522,651

(22) Filed: Jul. 26, 2019

(30) Foreign Application Priority Data
Oct. 25, 2018 (CN) 201811248291.0

(51) Int. Cl. B29D 35/00; B29D 35/04; A43B 1/10

(52) U.S. Cl. CPC B29D 35/0009; B29K 2021/00; A43B 1/10; B29D 35/04

(57) ABSTRACT

A method for manufacturing a rubber boot having a foamed layer includes a first step of coating of boot-shaped lining sheath and a second step of rubber injection. A boot-sole-section coating layer, a boot-vamp-section coating layer, a boot-heel-section coating layer, and a boot-shaft-section coating layer that are coated on a boot-shaped lining sheath, after cured, provide a hardened surface and a stiff support structure among the coating layers that help melted rubber to efficiently flow and fill up runners inside a mold to thereby prevent defects from being formed in a rubber layer formed on a surface of a rubber boot so manufactured.

### TECHNICAL FIELD OF THE INVENTION

The present invention relates to a method for manufacturing a rubber boot with a foamed lining layer, and particularly to a method that involves an injection operation to directly inject a rubber material to attach to an outside surface of a boot-shaped lining sheath and to form a rubber layer on a boot-sole section, a boot-vamp section, a boot-heel section, and a boot-shaft section of boot-shaped lining sheath, so that the boot-shaped lining sheath is structured to include a foamed layer of a predetermined thickness to thereby provide a rubber boot that is made to achieve full-area softness and comfort and featuring effects of waterproofness and warm-keeping and also helps greatly enhance fabrication efficiency of rubber boots.

### DESCRIPTION OF THE PRIOR ART

People often take certain working or leisure activities in daily living, and proper footwears, such as boots, must be worn in order to capably carry out such activities. Boots for such purposes must qualify by possessing features of wear resistance, water resistance, light weight, and softness or flexibility. For such requirements, the Applicant proposed, in Chinese Patent No. 201610019912.2 filed on Jan. 13, 2016, a process for manufacturing rubber footwears. The process is applicable to fabrication of rubber footwears showing the characteristics of being wear resistant, waterproof, light in weight, and soft, and various diversified models are available for such rubber footwear. However, a footwear made with such a process includes a sole that is filled with polyurethane (PU) to form a midsole. The midsole is soft and light-weighted and makes a great improvement concerning comfortableness of the sole of a rubber footwear made with such a known process. However, there are deficiencies for such a known process to be improved:

(1) In the known process, decorative pieces for various parts of the rubber footwear must be prepared in advance to show various shapes as a sole decoration piece, a heel decoration piece, a vamp decoration piece, and a shaft decorative piece. Inventory management is necessary for such different parts, footwears of different models involve decorative pieces of different shapes. In such a process, in making the decorative pieces, a first operation must be carried out, and in shaping into a rubber footwear, a second operation of shaping and processing must be carried out. These make the entire process complicated and tedious. In addition, there is also loading for inventory management and stocking of these parts. Thus, the efficiency of manufacturing with such a process requires further improvement.

(2) In such a known process, PU is only filled in a portion that makes the midsole of a rubber footwear made with such a process. However, other portions of the boot that are in contact with different portions a foot wearing the footwear, such as the instep, the heel, and the shank, are not filled with or added with a soft foamed layer, so that overall comfortableness and warm-keeping property of the entire footwear must be further improved.

### SUMMARY OF THE INVENTION

The primary objective of the present invention is to allow a rubber material to directly attach to an outside surface of a boot-shaped lining sheath through injection in order to make a rubber boot, so that an operation of making decorative rubber pieces in advance can be eliminated and the efficiency of making rubber boots can be greatly improved.

A second objective of the present invention is to provide various portions, including a boot-sole section, a boot-vamp section, a boot-heel section, and a boot-shaft section of a manufactured rubber boot with full-area properties of comfort and warm-keeping and waterproofness.

To achieve the above objectives, the present invention provides a method that comprises three steps:

a first step comprising coating of boot-shaped lining sheath, in which a flexible foamed material having a predetermined thickness is processed to form a boot-shaped lining sheath and a rubber coating layer that is curable is coated on a boot-sole section, a boot-vamp section, a boot-heel section, and a part or entirety of a boot-shaft section of the boot-shaped lining sheath so as to form a boot-sole-section coating layer, a boot-vamp-section coating layer, a boot-heel-section coating layer, and a boot-shaft-section coating layer;

a second step comprising rubber injection, in which the boot-shaped lining sheath that is coated with the rubber coating layer is fit to a multi-segment last of an injection apparatus, and a first mold member and a second mold member that are arranged at a left side and a right side of the injection apparatus and a third mold member are operated to enclose the boot-shaped lining sheath that is coated with the rubber coating layer, wherein the first mold member and the second mold member have a first mold cavity and a second mold cavity that are configured to include, in a recessed form, boot-shaft forming sections, boot-vamp forming sections, and boot-heel forming sections that respectively correspond to the boot-shaft-section coating layer, the boot-vamp-section coating layer, and the boot-heel-section coating layer of the boot-shaped lining sheath, each with a gap formed and connected therebetween to serve as a runner; and the third mold member has a third mold cavity that is configured to include, in a recessed form, a boot-sole forming section that corresponds to the boot-sole-section coating layer of boot-shaped lining sheath, a gap being formed and connected between the third mold cavity of the third mold member and the boot-sole-section coating layer of boot-shaped lining sheath to serve as a runner connected to the boot-vamp forming sections, the boot-heel forming sections, and the boot-shaft forming sections of the first mold member and the second mold member; and wherein rubber that is melted through heating is injected into the third mold cavity of the third mold member, and the melted rubber injected into the third mold cavity flows along the runner between the boot-sole-section coating layer of the boot-shaped lining sheath and the boot-sole forming section of the third mold cavity, the runner between the boot-vamp-section coating layer of the boot-shaped lining sheath and the boot-vamp forming sections of the first mold cavity and the second mold cavity, and the runner between the boot-heel-section coating layer of the boot-shaped lining sheath and the boot-heel forming sections of the first mold cavity and the second mold cavity into the runner between the boot-shaft-section coating layer of the boot-shaped lining sheath and the boot-shaft forming sections of the first mold cavity and the second mold cavity to completely fill up the runners, wherein the boot-shaft-section coating layer, the boot-vamp-section coating layer, the boot-heel-section coating layer, and the boot-sole-section coating layer of the boot-shaped lining sheath are heated and melted by the injected melted rubber and are fused and combined with the injected melted rubber, wherein after cooling, a product of a rubber boot is formed and removed with the boot-sole section, the boot-vamp section, the boot-heel section, and the boot-shaft section of the boot-shaped lining sheath form a boot-sole rubber layer, a boot-vamp rubber layer, a boot-heel rubber layer, and a boot-shaft rubber layer of a predetermined thickness; and

a third step comprising beautifying, in which extra flashing is removed and open edges of the boot-shaped lining sheath are covered and beautified to thereby provide a multifunctional rubber boot that exhibits diversified surface appearances and features light weight, water resistance, and wear resistance, and having a full-area covered soft lining.

### BRIEF DESCRIPTION OF THE DRAWINGS

FIGS. 1, 2, and 3 are perspective views, taken from different angles, showing a boot-shaped lining sheath according to the present invention.

FIGS. 4, 5, and 6 are perspective views, taken from different angles, showing the boot-shaped lining sheath that is coated with a rubber coating layer according to the present invention.

FIG. 7 is a schematic view showing a condition before the boot-shaped lining sheath is fit to a last according to the present invention.

FIG. 8 is a schematic view illustrating a condition before mold closure according to the present invention.

FIG. 9 is a schematic view illustrating a condition where first and second mold members are closed, while a third mold member is not yet closed according to the present invention.

FIG. 10 is a cross-sectional view illustrating a condition before injection is carried out.

FIG. 11 is a cross-sectional view illustrating a condition after injection is carried out.

FIG. 12 a schematic view illustrating a rubber boot is removed from a last after the injection is completed according to the present invention.

FIGS. 13 and 14 are perspective views, taken from different angles, showing a rubber boot manufactured with the present invention.

### DETAILED DESCRIPTION OF THE PREFERRED EMBODIMENT

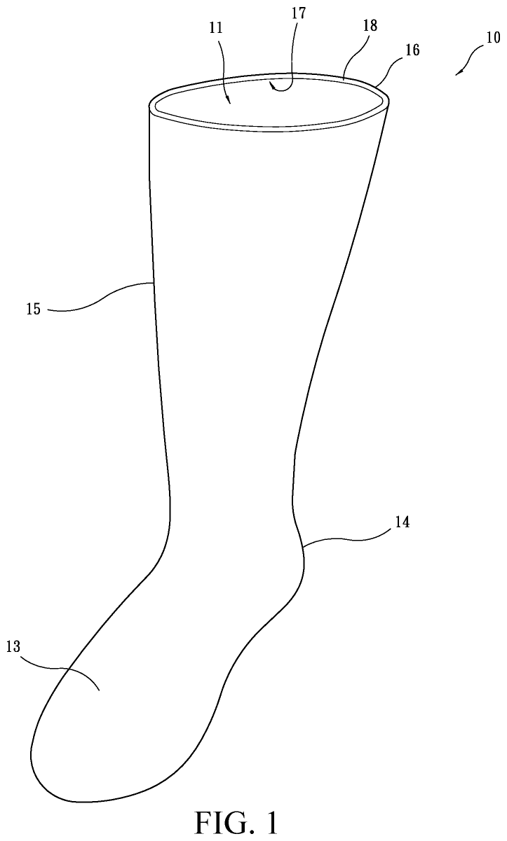

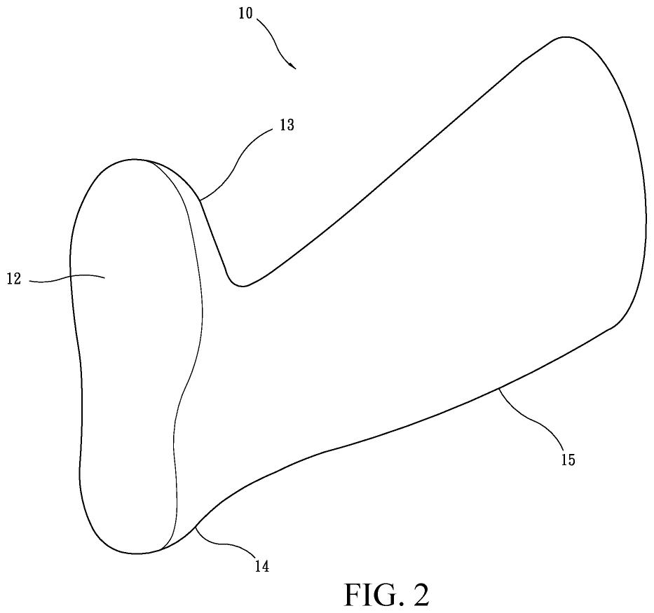

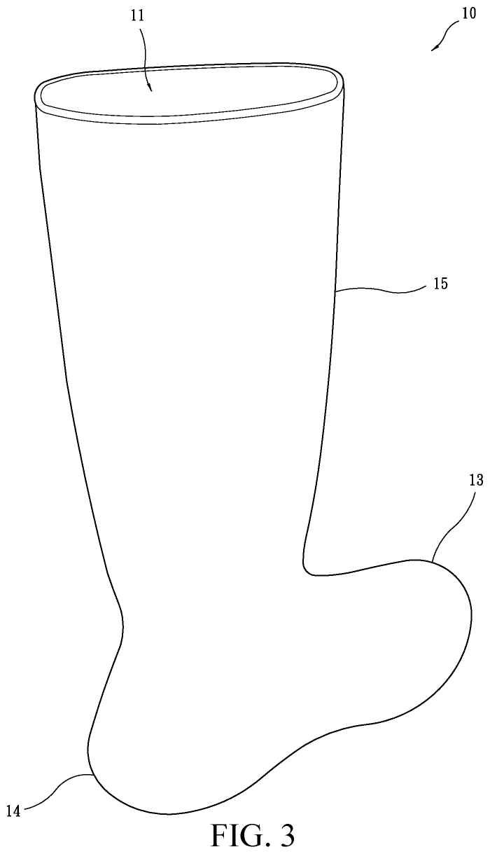

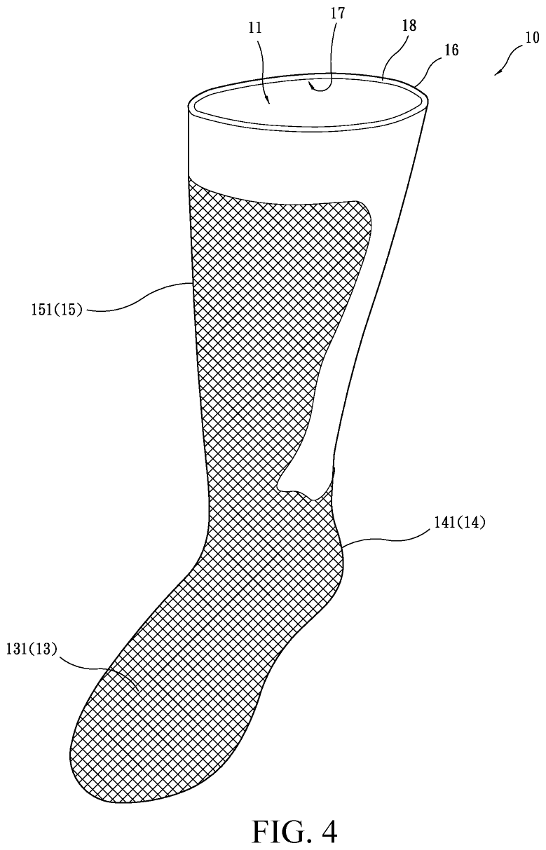

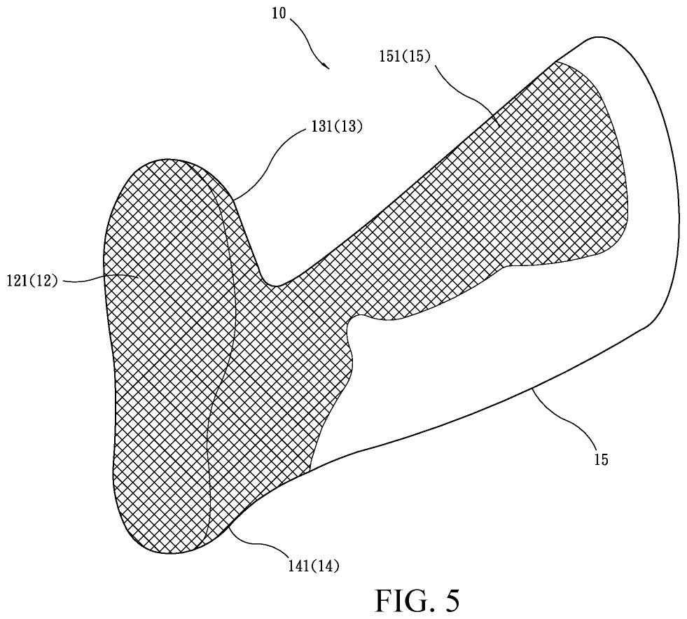

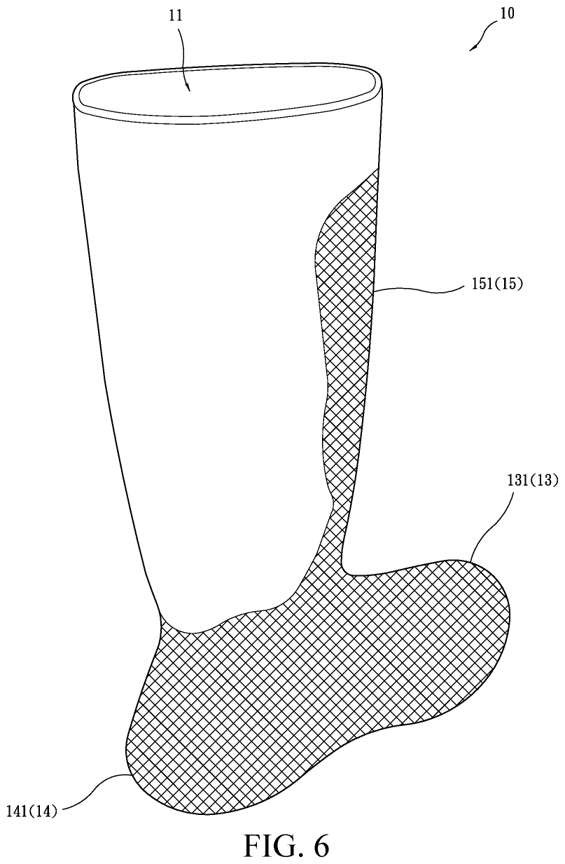

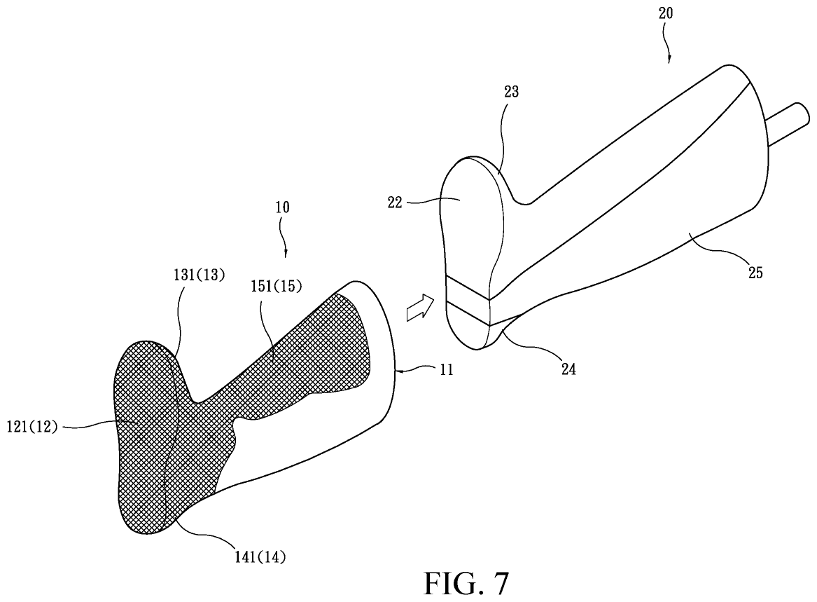

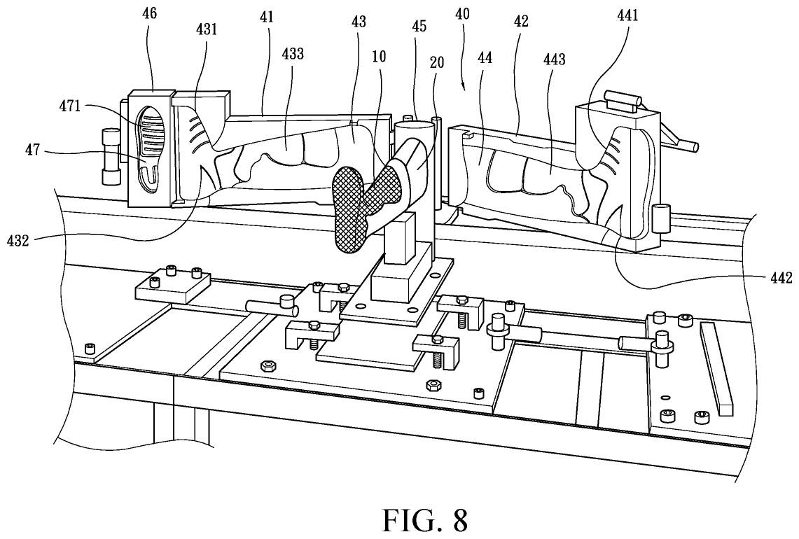

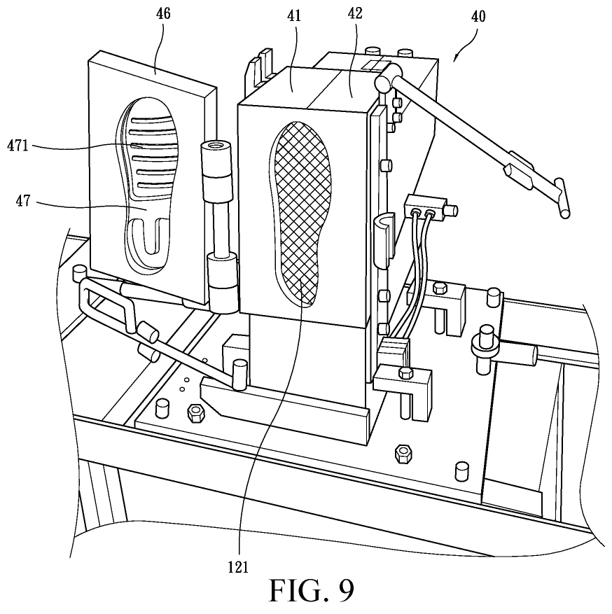

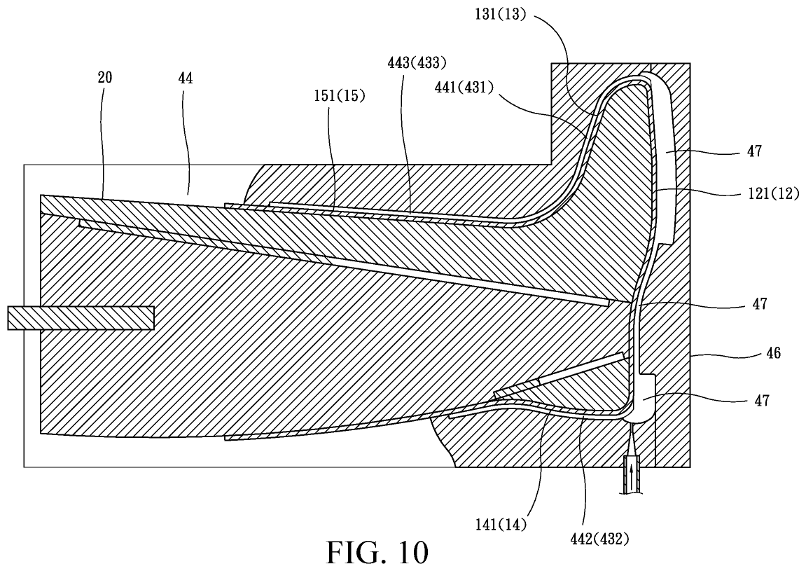

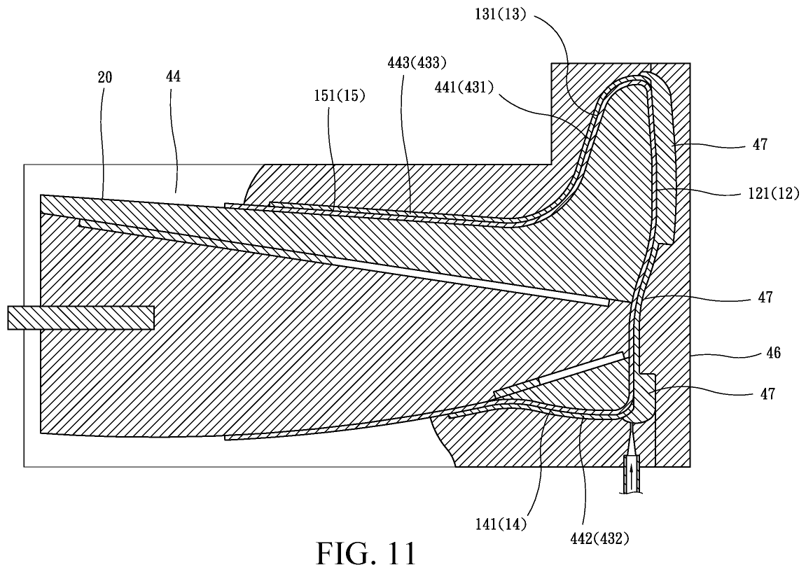

Referring first to FIGS. 1-14, the present invention provides, in an embodiment thereof, a method for manufacturing a rubber boot having a foamed lining layer, and the method comprises the following steps:

A first step is coating of boot-shaped lining sheath, in which a flexible foamed material having a predetermined thickness is processed or handled to form a boot-shaped lining sheath 10 and a rubber coating layer that is curable and may get hardened is coated on a boot-sole section 12, a boot-vamp section 13, a boot-heel section 14, and a part or entirety of a boot-shaft section 15 of the boot-shaped lining sheath 10 so as to form, respectively, a boot-sole-section coating layer 121, a boot-vamp-section coating layer 131, a boot-heel-section coating layer 141, and a boot-shaft-section coating layer 151. The boot-shaped lining sheath 10 can be formed by cutting or trimming a planar sheet of a foamed material, followed by sewing or stitching to make a boot-shaped lining sheath; and the boot-sole-section coating layer 121, the boot-vamp-section coating layer 131, the boot-heel-section coating layer 141, and the boot-shaft-section coating layer 151 can be coated, in advance, on corresponding portions of the planar foamed material. The foamed material has an outside surface that is provided with a thin outer skin layer 16, such as a cloth layer, and an inside surface that is provided with a thin inner skin layer 17, such as a cloth layer. The outer skin layer 16 and the inner skin layer 17 sandwich therebetween a foamed layer 18. The foamed layer 18 can be made of a material comprising a soft or flexible foamed object of plastics or rubber and may include a foamed object having a material of at least polyurethane (PU), ethylene vinyl acetate (EVA), thermoplastic polyurethane (TPU), thermoplastic rubber (TPR), or styrene butadiene rubber (SBR). Manufacturing or forming of the boot-shaped lining sheath 10 may be alternatively carried out with an injection operation and such an injected boot-shaped lining sheath 10 may be made without the outer skin layer 16 and the inner skin layer 17.

A second step is rubber injection, in which the boot-shaped lining sheath 10 that is coated with the rubber coating layer is sleeved over a multi-segment last 20 of an injection apparatus 40. The multi-segment last comprises a last-sole section 22, a last-vamp section 23, a last-heel section 24, and a last-shaft section 25. A first mold member 41 and a second mold member 42 that are arranged at a left side and a right side of the injection apparatus, respectively, are operated to close and thus enclose the boot-shaped lining sheath 10 that is coated with the rubber coating layer therebetween such that only the boot-sole-section coating layer 121 of the boot-shaped lining sheath 10 is exposed, and then, a third mold member 46 is operated to collaborate with the first mold member 41 and the second mold member 42 to completely enclose the boot-shaped lining sheath 10, wherein the first mold member 41 and the second mold member 42 have a first mold cavity 43 and a second mold cavity 44 that are configured to include, in a recessed form, boot-shaft forming sections 433, 443, boot-vamp forming sections 431, 441, and boot-heel forming sections 432, 442 that respectively correspond to the boot-shaft-section coating layer 151, the boot-vamp-section coating layer 131, and the boot-heel-section coating layer 141 of the boot-shaped lining sheath 10, each with a gap formed and connected therebetween, and in alternative or additional connection with each other, to serve as a runner; and the third mold member 46 has a third mold cavity 47 that is configured to include, in a recessed form, a boot-sole forming section 471 that corresponds to the boot-sole-section coating layer 121 of boot-shaped lining sheath 10, a gap being formed and connected between the third mold cavity 47 of the third mold member 46 and the boot-sole-section coating layer 121 of boot-shaped lining sheath 10 to serve as a runner connected to the boot-vamp forming sections 431, 441, the boot-heel forming sections 432, 442, and the boot-shaft forming sections 433, 443 of the first mold member 41 and the second mold member 42. Afterwards, rubber that is melted through heating is injected into the third mold cavity 47 of the third mold member 46, and the melted rubber so injected into the third mold cavity 47 flows along the runner between the boot-sole-section coating layer 121 of the boot-shaped lining sheath 10 and the boot-sole forming section 471 of the third mold cavity 47, the runner between the boot-vamp-section coating layer 131 of the boot-shaped lining sheath 10 and the boot-vamp forming sections 431, 441 of the first mold cavity 43 and the second mold cavity 44, and the runner between the boot-heel-section coating layer 141 of the boot-shaped lining sheath 10 and the boot-heel forming sections 432, 442 of the first mold cavity 43 and the second mold cavity 44 into the runner between the boot-shaft-section coating layer 151 of the boot-shaped lining sheath 10 and the boot-shaft forming sections 433, 443 of the first mold cavity 43 and the second mold cavity 44 to completely fill full of the runners. The boot-shaft-section coating layer 151, the boot-vamp-section coating layer 131, the boot-heel-section coating layer 141, and the boot-sole-section coating layer 121 of the boot-shaped lining sheath 10 are heated and thus melted by the melted rubber so injected and thus fused and combined with the injected rubber. After cooling, a product of a rubber boot 30 is removed and portions of the boot-shaped lining sheath 10, including the boot-sole section 12, the boot-vamp section 13, the boot-heel section 14, and the boot-shaft section 15, would form a boot-sole rubber layer 32, a boot-vamp rubber layer 33, a boot-heel rubber layer 34, and a boot-shaft rubber layer 35 that each have a predetermined thickness to thus form a completely integrated and unitary outside appearance. The technical features of the present invention are that the boot-sole-section coating layer 121, the boot-vamp-section coating layer 131, the boot-heel-section coating layer 141, and the boot-shaft-section coating layer 151 that are coated on the boot-shaped lining sheath 10, once cured, provide hardened surface and the coating layer, once cured, provide a stiff support structure, both helping the heat-melted rubber to smoothly and efficiently flow and fill up the runners. In other words, the method of the present invention effectively handles the problem that the boot-shaped lining sheath 10 that is generally of a certain thickness and thus excessively soft would hinder heat-melted rubber of an injection operation from smoothly and efficiently flowing due to a soft surface of the boot-shaped lining sheath 10, if the injection operation is carried out without first making the coating of a curable and thus hardened rubber coating layer on the boot-shaped lining sheath 10, and in addition, the excessively soft surface of the boot-shaped lining sheath 10 may be susceptible to deformation, making the surface irregular and exhibiting corrugating, which further hinder smooth flowing of the heat-melted rubber, such a problem leading to defects in a rubber layer formed on a surface of a rubber boot so made.

A third step is beautifying, in which extra flashing is removed and open edges of the boot-shaped lining sheath are covered and beautified to thereby provide a multifunctional rubber boot that exhibits diversified surface appearances and features light weight, water resistance, and wear resistance, and having a full-area covered soft lining Flashing may be formed due to vent holes provided in the first mold member 41 and the second mold member 42 to help the melted rubber to flow.

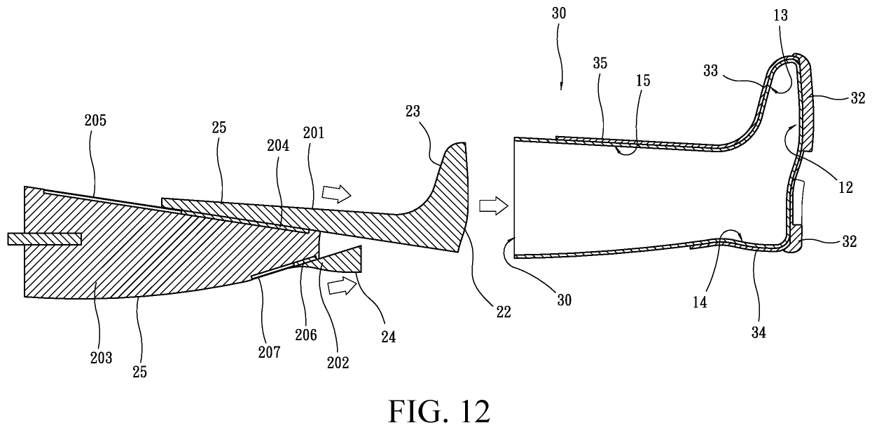

Referring to FIG. 12, to ease removal of a product of the rubber boot 30 from the last 20, the last 20 is made up of three separate parts, including a first slidable segment 201, a second slidable segment 202, and a non-slidable segment 203. The non-slidable segment 203 is fixed and is mounted to a fixing pillar 45 of the injection apparatus 40. The first slidable segment 201 is a part that forms a portion of the last-vamp section 23 and a portion of the last-shaft section 25 of the last 20. Contact surfaces of the first slidable segment 201 and the non-slidable segment 203 are engageable with each other through surface contact and are made inclined and a slide rack 204 and a slide channel 205 that mate each other is provided therebetween, so that the first slidable segment 201 is reciprocally movable on and relative to the non-slidable segment 203 and the slide rack 204 and the slide channel 205 arranged therebetween are inclined downward in a direction from the last-shaft section 25 toward the last-sole section 22. When the first slidable segment 201 moves in a direction toward the last-sole section 22, the first slidable segment 201 is gradually lowered in respect of the vertical position thereof and gradually approaches the second slidable segment 202. The second slidable segment 202 is a part that forms the boot-heel section 24 of the last 20. Contact surfaces of the second slidable segment 202 and the non-slidable segment 203 are engageable with each other through surface contact and are made inclined and a slide rack 206 and a slide channel 207 that mate each other is provided therebetween, so that the second slidable segment 202 is reciprocally movable on and relative to the non-slidable segment 203 and the slide rack 206 and the slide channel 207 arranged therebetween are inclined upward in a direction from the last-shaft section 25 toward the last-sole section 22. When the second slidable segment 202 moves in a direction toward the last-sole section 22, the second slidable segment 202 is gradually raised in respect of the vertical position thereof and gradually approaches the first slidable segment 201. When the first slidable segment 201 and the second slidable segment 202 both move in the direction toward the last-sole section 22, the product of rubber boot 30 can be readily removed from the last 20. Based on the same idea, before an injection operation is carried out, a boot-shaped lining sheath 10 can be readily mounted to the last 20.

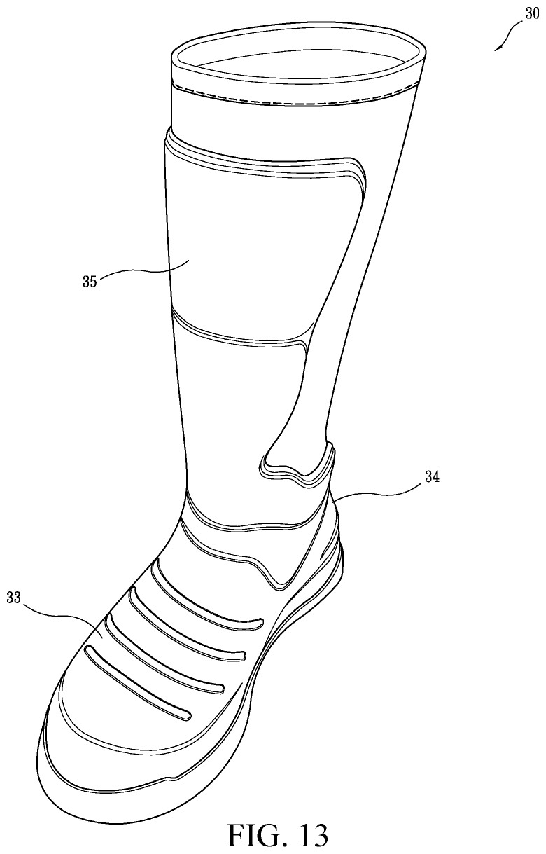

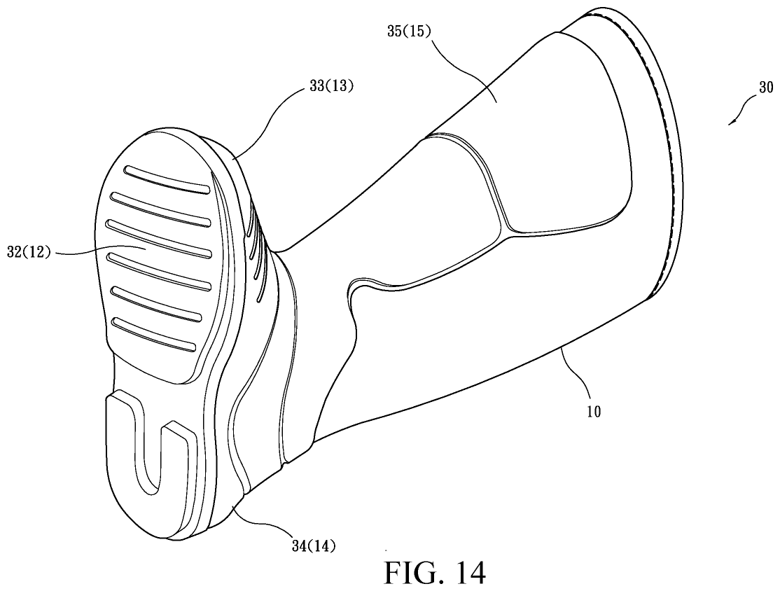

Referring to FIGS. 13 and 14, perspective views of a rubber boot 30 manufactured with the method of the present invention are shown, and a surface of the boot has portions that correspond to the boot-sole section 12, the boot-vamp section 13, the boot-heel section 14, the boot-shaft section 15 of the boot-shaped lining sheath 10 are provided with the boot-sole rubber layer 32, the boot-vamp rubber layer 33, the boot-heel rubber layer 34, and the boot-shaft rubber layer 35 having a predetermined thickness to form a completely integrated and unitary surface configuration. The boot-sole rubber layer 32, the boot-vamp rubber layer 33, the boot-heel rubber layer 34, and the boot-shaft rubber layer 35 provide the rubber boot 30 with excellent property of wear resistance. The boot-shaped lining sheath 10 provides the rubber boot 30 with features of softness and comfort, warm-keeping, and waterproofness. If desired, secondary processing may be performed to provide the rubber boot 30 with proper property of air breathing

I claim:

1. A method for manufacturing a rubber boot with a foamed lining layer, comprising two steps:
a first step comprising coating of boot-shaped lining sheath, in which a flexible foamed material having a predetermined thickness is processed to form a boot-shaped lining sheath and a rubber coating layer that is curable is coated on a boot-sole section, a boot-vamp section, a boot-heel section, and a part or entirety of a boot-shaft section of the boot-shaped lining sheath so as to form a boot-sole-section coating layer, a boot-vamp-section coating layer, a boot-heel-section coating layer, and a boot-shaft-section coating layer; and
a second step comprising rubber injection, in which the boot-shaped lining sheath that is coated with the rubber coating layer is fit to a multi-segment last of an injection apparatus, and a first mold member and a second mold member that are arranged at a left side and a right side of the injection apparatus and a third mold member are operated to enclose the boot-shaped lining sheath that is coated with the rubber coating layer, wherein the first mold member and the second mold member have a first mold cavity and a second mold cavity that are configured to include, in a recessed form, boot-shaft forming sections, boot-vamp forming sections, and boot-heel forming sections that respectively correspond to the boot-shaft-section coating layer, the boot-vamp-section coating layer, and the boot-heel-section coating layer of the boot-shaped lining sheath, each with a gap formed and connected therebetween to serve as a runner; and the third mold member has a third mold cavity that is configured to include, in a recessed form, a boot-sole forming section that corresponds to the boot-sole-section coating layer of boot-shaped lining sheath, a gap being formed and connected between the third mold cavity of the third mold member and the boot-sole-section coating layer of boot-shaped lining sheath to serve as a runner connected to the boot-vamp forming sections, the boot-heel forming sections, and the boot-shaft forming sections of the first mold member and the second mold member; and
wherein rubber that is melted through heating is injected into the third mold cavity of the third mold member, and the melted rubber injected into the third mold cavity flows along the runner between the boot-sole-section coating layer of the boot-shaped lining sheath and the boot-sole forming section of the third mold cavity, the runner between the boot-vamp-section coating layer of the boot-shaped lining sheath and the boot-vamp forming sections of the first mold cavity and the second mold cavity, and the runner between the boot-heel-section coating layer of the boot-shaped lining sheath and the boot-heel forming sections of the first mold cavity and the second mold cavity into the runner between the boot-shaft-section coating layer of the boot-shaped lining sheath and the boot-shaft forming sections of the first mold cavity and the second mold cavity to completely fill up the runners, wherein the boot-shaft-section coating layer, the boot-vamp-section coating layer, the boot-heel-section coating layer, and the boot-sole-section coating layer of the boot-shaped lining sheath are heated and melted by the injected melted rubber and are fused and combined with the injected melted rubber, wherein after cooling, a product of a rubber boot is formed and removed with the boot-sole section, the boot-vamp section, the boot-heel section, and the boot-shaft section of the boot-shaped lining sheath form a boot-sole rubber layer, a boot-vamp rubber layer, a boot-heel rubber layer, and a boot-shaft rubber layer of a predetermined thickness.

2. The method for manufacturing a rubber boot with a foamed lining layer according to claim 1 further comprising a third step, wherein the third step comprises a beautifying operation, in which flashing is removed and open edges of the boot-shaped lining sheath are covered and beautified.

3. The method for manufacturing a rubber boot with a foamed lining layer according to claim 1, wherein the multi-segment last comprises a first slidable segment, a second slidable segment, and a non-slidable segment, wherein the non-slidable segment is fixed and is securely mounted to the injection apparatus; the first slidable segment comprises a part of the boot-vamp section and a part of the boot-shaft section of the last, the first slidable segment and the non-slidable segment having contact surfaces therebetween that are set in surface contact engagement with each other and are inclined with a slide rack and a slide channel that are in mating engagement with each other being provided therebetween, so that the first slidable segment is reciprocally movable on the non-slidable segment and the slide rack and the slide channel arranged therebetween are inclined downward in a direction from the last-shaft section toward the last-sole section, wherein when the first slidable segment moves in a direction toward the last-sole section, the first slidable segment is gradually lowered in respect of the vertical position thereof and gradually approaches the second slidable segment; and the second slidable segment corresponds to the boot-heel section, the second slidable segment and the non-slidable segment having contact surfaces therebetween that are set in surface contact engagement with each other and are inclined with a slide rack and a slide channel that are in mating engagement with each other being provided therebetween, so that the second slidable segment is reciprocally movable on the non-slidable segment and the slide rack and the slide channel arranged therebetween are inclined upward in a direction from the last-shaft section toward the last-sole section, wherein when the second slidable segment moves in a direction toward the last-sole section, the second slidable segment is gradually raised in respect of the vertical position thereof and gradually approaches the first slidable segment.

4. The method for manufacturing a rubber boot with a foamed lining layer according to claim 1, wherein the foamed layer of the boot-shaped lining sheath comprises a foamed material of plastics or rubbers.

5. The method for manufacturing a rubber boot with a foamed lining layer according to claim 1, wherein the foamed layer of the boot-shaped lining sheath comprises a material that comprises a foamed material of polyurethane (PU), ethylene vinyl acetate (EVA), thermoplastic polyurethane (TPU), thermoplastic rubber (TPR), or styrene butadiene rubber (SBR).

6. The method for manufacturing a rubber boot with a foamed lining layer according to claim 1, wherein the foamed material has an outside surface including a thin outer cloth layer and an inside surface including a thin inner cloth layer.

7. The method for manufacturing a rubber boot with a foamed lining layer according to claim 1, wherein the first mold member and the second mold member are provided with vent holes.
